(19) United States
(12) Patent Application Publication
(10) Pub. No.: US 2026/0088726 A1
(43) Pub. Date: Mar. 26, 2026

(54) SWITCHING CONVERTER WITH LOW POWER CONSUMPTION

(71) Applicant: Chengdu Monolithic Power Systems Co., Ltd., Chengdu (CN)

(72) Inventors: Yuedong Chen, Chengdu (CN); Junlin Qian, Chengdu (CN); Hui Li, Hangzhou (CN)

(21) Appl. No.: 19/404,804

(22) Filed: Dec. 1, 2025

Related U.S. Application Data
(63) Continuation-in-part of application No. 19/000,651, filed on Dec. 23, 2024.

(30) Foreign Application Priority Data
Dec. 25, 2023 (CN) 202311806870.3

(51) Int. Cl. H02M 3/335

(52) U.S. Cl. CPC H02M 3/33576

(57) ABSTRACT

A control circuit for a switching converter. The control circuit includes a first pin and a secondary control circuit with a transmitter. The secondary control circuit determines whether to enter a low power mode from a normal power mode based on a voltage at the first pin. The transmitter is configured to modulate a secondary sync signal and to transmit the modulated secondary sync signal to a primary control circuit when the secondary control circuit is in the normal power mode and configured to be disabled when the secondary control circuit is in the low power mode.

### CROSS-REFERENCE TO RELATED APPLICATIONS

This application is a continuation-in-part of US patent application Ser. No. 19/000,651, filed on Dec. 23, 2024, which claims the benefit of CN patent application 202311806870.3, filed on Dec. 25, 2023. All of these related applications are incorporated herein by reference in their entirety.

### TECHNICAL FIELD OF THE INVENTION

The present invention generally relates to electronic circuits, and more particularly but not exclusively, to switching converters with low power consumption and associated control circuits.

### BACKGROUND OF THE INVENTION

With the increasing importance of energy efficiency and environmental protection and the quick development of switching power supply technology, customers expect more and more on the efficiency of switching power supply products. For example, more and more customers require switching power supply products with extremely low no load power consumption. In order to improve the no load efficiency or the light load efficiency, common switching power supplies use many technologies, such as pulse skipping mode, burst mode and so on, to reduce the switching loss under no load or light load condition. However, there is still certain power loss when these switching power supplies operate under no load or light load condition, which cannot satisfy the extremely low no-load power consumption requirement.

### SUMMARY OF THE INVENTION

An embodiment of the present invention discloses a control circuit for a switching converter. The control circuit includes a first pin and a secondary control circuit. The secondary control circuit includes a transmitter and is configured to determine whether to enter a low power mode from a normal power mode based on a voltage at the first pin. The transmitter is configured to be enabled to modulate a secondary sync signal and to transmit the modulated secondary sync signal to a primary control circuit when the secondary control circuit is in the normal power mode and is configured to be disabled when the secondary control circuit is in the low power mode.

An embodiment of the present invention discloses a switching converter. The switching converter includes a transformer, a primary switch, a secondary switch and a control circuit. The transformer has a primary winding and a secondary winding. The primary switch is coupled to the primary winding. The secondary switch is coupled to the secondary winding. The control circuit is configured to control the primary switch and the secondary switch. The control circuit includes a first pin, a secondary control circuit including a transmitter and a primary control circuit including a receiver. The secondary control circuit is configured to determine whether to enter a low power mode from a normal power mode based on a voltage at the first pin. The transmitter is configured to be enabled to modulate a secondary sync signal and to transmit the modulated secondary sync signal to the receiver when the secondary control circuit is in the normal power mode, and is configured to be disabled when the secondary control circuit is in the low power mode. The receiver is configured to be enabled to demodulate the modulated secondary sync signal and to generate a primary sync signal to control the primary switch when the primary control circuit is in the normal power mode and is configured to be disabled when the primary control circuit is in the low power mode.

An embodiment of the present invention discloses control method for a switching converter. The control method includes the following steps: 1) Detecting a feedback voltage indicating a load condition of the switching converter. 2) Determining whether a secondary control circuit to enter a low power mode from a normal power mode based on the feedback voltage. 3) Enabling a transmitter to modulate a secondary sync signal and transmit the modulated secondary sync signal to a receiver when the secondary control circuit is in the normal power mode. And 4) disabling the transmitter when the secondary control circuit is in the low power mode.

### BRIEF DESCRIPTION OF DRAWINGS

The present invention can be further understood with reference to the following detailed description and the appended drawings, wherein like elements are provided with like reference numerals.

FIG. 1 illustrates a block diagram of a switching converter 100 in accordance with an embodiment of the present invention.

FIG. 2 illustrates a circuit schematic of a switching converter 200A in accordance with another embodiment of the present invention.

FIG. 3 illustrates a circuit schematic of a control circuit 12B used in the switching converter 200A with an embodiment of the present invention.

FIG. 4 illustrates a working flowchart of the control circuit 12B and a PD controller 13A during a time period when a load is disconnected from the switching converter 200A in accordance with an embodiment of the present invention.

FIG. 5 illustrates a working waveform of the switching converter 200A in accordance with an embodiment of the present invention.

FIG. 6 illustrates a circuit schematic of a switching converter 200B in accordance with an embodiment of the present invention.

FIG. 7 illustrates a circuit schematic of a switching converter 200C in accordance with an embodiment of the present invention.

FIG. 8 illustrates a circuit schematic of a control circuit 12D used in the switching converter 200C in accordance with an embodiment of the present invention.

FIG. 9 illustrates a working flowchart of the control circuit 12D and a PD controller 13C during a time period when a load is disconnected from the switching converter 200C in accordance with an embodiment of the present invention.

FIG. 10 illustrates a working waveform of the switching converter 200C in accordance with an embodiment of the present invention.

FIG. 11 illustrates a circuit schematic of a switching converter 300 in accordance with an embodiment of the present invention.

FIG. 12 illustrates a circuit schematic of a switching converter 400 in accordance with an embodiment of the present invention.

FIG. 13 illustrates a working waveform of the switching converter 400 in accordance with an embodiment of the present invention.

FIG. 14 illustrates a circuit schematic of a switching converter 400A in accordance with another embodiment of the present invention.

FIG. 15 illustrates a working waveform of the switching converter 400A in accordance with an embodiment of the present invention.

FIG. 16 illustrates a circuit schematic of a switching converter 400B in accordance with an embodiment of the present invention.

FIG. 17 illustrates a working waveform of the switching converter 400B in accordance with an embodiment of the present invention.

FIG. 18 illustrates a circuit schematic of a switching converter 400C in accordance with an embodiment of the present invention.

FIG. 19 illustrates a working waveform of the switching converter 400C in accordance with an embodiment of the present invention.

FIG. 20 illustrates a circuit schematic of the switching converter 400D in accordance with another embodiment of the present invention.

FIG. 21 illustrates a circuit schematic of a switching converter 400E in accordance with another embodiment of the present invention.

FIG. 22 illustrates a working flowchart of a control method 500 for a switching converter in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

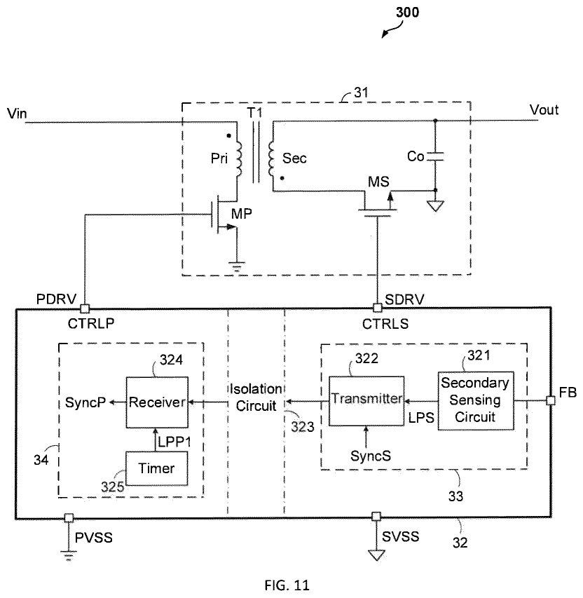

The present application is CIP of U.S. patent application Ser. No. 19/000,651. The new added embodiments start from FIG. 11.

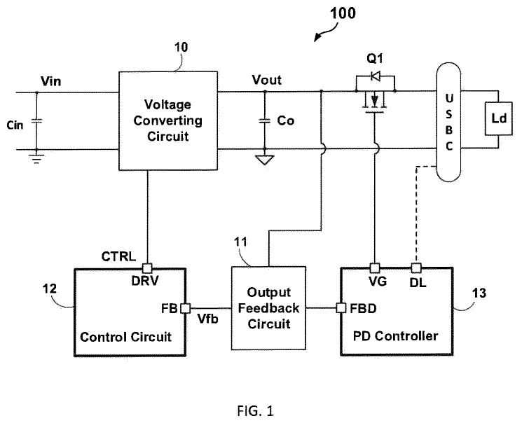

FIG. 1 illustrates a block diagram of a switching converter 100 in accordance with an embodiment of the present invention. In the example shown in FIG. 1, the switching converter 100 includes an input capacitor Cin, a voltage converting circuit 10, an output capacitor Co, an output feedback circuit 11 and a control circuit 12.

The voltage converting circuit 10 includes a power switch (not shown) and converts an input voltage Vin into an output voltage Vout to power a load Ld via the turning-on and the turning-off of the power switch. The output feedback circuit 11 is coupled to an output terminal of the voltage converting circuit 10 and generates an output feedback signal Vfb.

The control circuit 12 has a plurality of pins, including a feedback pin FB and a driving pin DRV. The feedback pin FB is coupled to the output feedback circuit 11 and the control circuit 12 receives the output feedback signal Vfb through the feedback pin FB. The driving pin DRV is coupled to the voltage converting circuit 10 and the control circuit 12 provides a switch control signal CTRL to control the voltage converting circuit 10 through the driving pin DRV.

In one embodiment, during the time period when the load is connected to the switching converter 100, the output feedback circuit 11 is configured to be a normal connection state and the control circuit 12 is configured to operate in a normal work mode.

Those skilled in the art can understand that the normal connection state of the output feedback circuit 11 refers that the output feedback circuit 11 is coupled to the output terminal of the voltage converting circuit 10 normally and the generated output feedback signal Vfb can represent the output voltage Vout. Then the output voltage Vout can be regulated to an expected value based on the output feedback signal Vfb. The normal work mode of the control circuit 12 refers that the control circuit 12 generates the switch control signal CTRL based on the output feedback signal Vfb indicative of the output voltage Vout and regulates the output voltage Vout to the expected value. Meanwhile, function blocks of the control circuit 12, such as overload protection function and so on, are enabled.

In one embodiment, during the time period when the load is disconnected from the switching converter 100, the output feedback circuit 11 is configured to be a cut off connection state for certain time periods. In response to the cut off connection state of the output feedback circuit 11, the control circuit 12 is configured to enter a sleep mode.

Those skilled in the art can understand that the cut off connection state of the output feedback circuit 11 refers that the output feedback circuit 11 is open and there is substantially no current flowing through the output feedback circuit 11. The sleep mode of the control circuit 12 refers that the switch control signal CTRL keeps invalid (e.g., logic low), the power switch of the voltage converting circuit 10 keeps off and the switching converter 100 stops switching. Meanwhile, some function blocks of the control circuit 12, such as the overload protection function, are disabled. In one embodiment, the overload protection function is used to detect whether overload occurs and to turn off or restart the switching converter 100 when the overload is detected.

According to the embodiment of the present invention, during the time period when the load is disconnected from the switching converter 100, the output feedback circuit 11 is configured to be the cut off connection state for certain time periods, and the control circuit 12 operates in the sleep mode. This can help reduce the power loss and then the switching converter 100 has extremely low no load power consumption.

Those skilled in the art can understand that during the time period when the load is disconnected from the switching converter 100, besides the cut off connection state, the output feedback circuit 11 can also be configured to be other states, such as the normal connection state and a short to ground state, which will be described in detail in the following embodiments. In one embodiment, the short to ground state of the output feedback circuit 11 refers that the output feedback circuit 11 is shorted and the current flowing through the output feedback circuit 11 reaches maximum.

Continue referring to FIG. 1, the switching converter 100 further includes a switch Q1, a USB port USBC and a PD (power delivery) controller 13.

As shown in FIG. 1, the PD controller 13 has a plurality of pins, including a pin VG coupled to the switch Q1 and a pin FBD coupled to the output feedback circuit 11. The PD controller 13 is configured to detect whether the load is disconnected from the switching converter 100. For example, the PD controller 13 can detect whether an electronic device is disconnected from the USB port USBC through a pin DL. In response to the load being disconnected from the switching converter 100 or being connected to the switching converter 100, the PD controller 13 is configured to configure the state of the output feedback circuit 11 through the pin FBD.

As shown in FIG. 1, the PD controller 13 is further configured to control the switch Q1 through the pin VG based on the power requirement of the USB port USBC, thereby configuring the voltage converting circuit 10 to power the USB port USBC. In one embodiment, in response to the load being disconnected from the USB port USBC, the switch Q1 is configured to be turned off to disconnect the USB port USBC from the voltage converting circuit 10 and the output capacitor Co, thereby avoiding the output voltage Vout reduces too much when the load is reconnected to the USB port USBC.

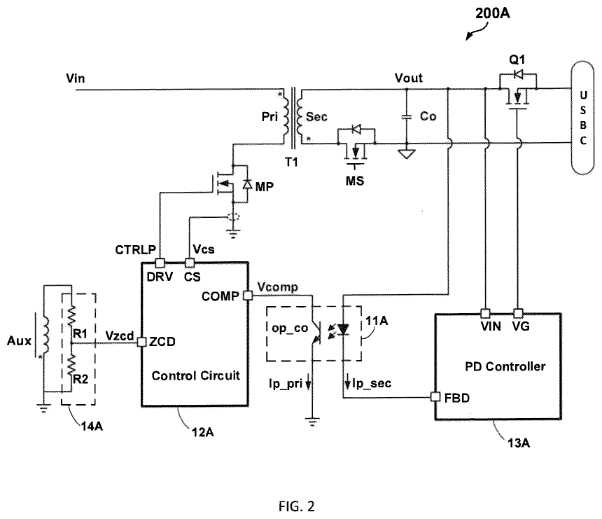

FIG. 2 illustrates a circuit schematic of a switching converter 200A in accordance with another embodiment of the present invention. As shown in FIG. 2, the switching converter 200A includes a transformer T1, a primary switch MP, a secondary switch MS, an output capacitor Co, an output feedback circuit 11A, a control circuit 12A and a PD controller 13A. The transformer T1 has a primary winding Pri and a secondary winding Sec, where both the primary winding Pri and the secondary winding Sec have a first terminal and a second terminal. The first terminal of the primary winding Pri is coupled to receive an input voltage Vin. The primary switch MP is coupled between the second terminal of the primary winding Pri and a primary reference ground. The first terminal of the secondary winding Sec is coupled to provide an output voltage Vout. The secondary switch MS is coupled between the second terminal of the secondary winding Sec and a secondary reference ground. The voltage across the output capacitor Co is the output voltage Vout. Those skilled in art can understand that the secondary switch MS can also be coupled between the first terminal of the secondary winding Sec and the output capacitor Co.

In the example shown in FIG. 2, the output feedback circuit 11A includes an optocoupler op_co. The optocoupler op_co has a photo sensitive device on the primary side and a light emitting device on the secondary side, where a first terminal of the light emitting device is coupled to the output voltage Vout.

The control circuit 12A has a plurality of pins, including a feedback pin COMP, a current sensing pin CS, a zero-crossing detecting pin ZCD and a driving pin DRV.

The feedback pin COMP is coupled to the photo sensitive device of the optocoupler op_co to receive an output feedback signal Vcomp. The current sensing pin CS is coupled to the primary switch MP to receive a primary current signal Vcs indicative of a current flowing through the primary switch MP. The zero-crossing detecting pin ZCD is coupled to an auxiliary winding Aux of the transformer T1 to detect a voltage across the auxiliary winding Aux. In the example shown in FIG. 2, the zero-crossing detecting pin ZCD is coupled to a voltage detecting circuit 14A to receive an auxiliary winding voltage signal Vzcd indicative of the voltage across the auxiliary winding Aux, where the voltage detecting circuit 14A includes resistors R1 and R2. The control circuit 12A is configured to provide a switch control signal CTRLP through the driving pin DRV to the primary switch MP to control the power operation of the switching converter 200A.

The PD controller 13A on the secondary side has a plurality of pins, including a pin FBD, a pin VIN and a pin VG. The pin FBD is coupled to the second terminal of the light emitting device of the optocoupler op_co. The PD controller 13A is configured to detect the output voltage Vout through the Pin VIN and to configure the state of the output feedback circuit 11A through the pin FBD.

In one embodiment, during the time period when the load is connected to the switching converter 200A, the PD controller 13A configures the output feedback circuit 11A to be the normal connection state. At this time, the output feedback signal Vcomp has a first state (e.g., the output feedback signal Vcomp can represent the output voltage Vout). In response to the first state of the output feedback signal Vcomp, the control circuit 12A operates in the normal work mode.

In one embodiment, during the time period when the load is disconnected from the switching converter 200A, the output feedback circuit 11A can be configured to be the cut off connection state or the short to ground state. In response to the cut off connection state or the short to ground state of the output feedback circuit 11A, the control circuit 12A is configured to enter the sleep mode or to exit the sleep mode. In one embodiment, the control circuit 12A determines whether to enter the sleep mode based on the auxiliary winding voltage signal Vzcd and determines whether to exit the sleep mode based on the output feedback signal Vcomp.

In a further embodiment, during the time period when the load is disconnected from the switching converter 200A, in response to the output voltage Vout decreasing to a first output threshold Vo1, the PD controller 13A configures the output feedback circuit 11A to be the cut off connection state (e.g., the PD controller 13A disconnects the second terminal of the light emitting device from the secondary reference ground through the pin FBD and a current Ip_dec flowing through the light emitting device is substantially zero). At this time, the output feedback signal Vcomp has a second state (e.g., the output feedback signal Vcomp reaches maximum). In response to the second state of the output feedback signal Vcomp, the output voltage Vout increases sharply and the auxiliary winding voltage signal Vzcd also increases sharply. In response to the sharp increase of the auxiliary winding voltage signal Vzcd, the control circuit 12A enters the sleep mode.

In another further embodiment, during the sleep mode, in response to the output voltage Vout decreasing to a second output threshold Vo2, the PD controller 13A configures the output feedback circuit 11A to be the short to ground state (e.g., the PD controller 13A shorts the pin FBD to the secondary reference ground and the current Ip_dec flowing through the light emitting device reaches maximum). At this time, the output feedback signal Vcomp has a third state (e.g., the output feedback signal Vcomp reaches minimum). In response to the output feedback signal Vcomp decreasing to a feedback threshold Vcompth, the control circuit 12A exits the sleep mode. In one embodiment, the second output threshold Vo2 is higher than the first output threshold Vo1.

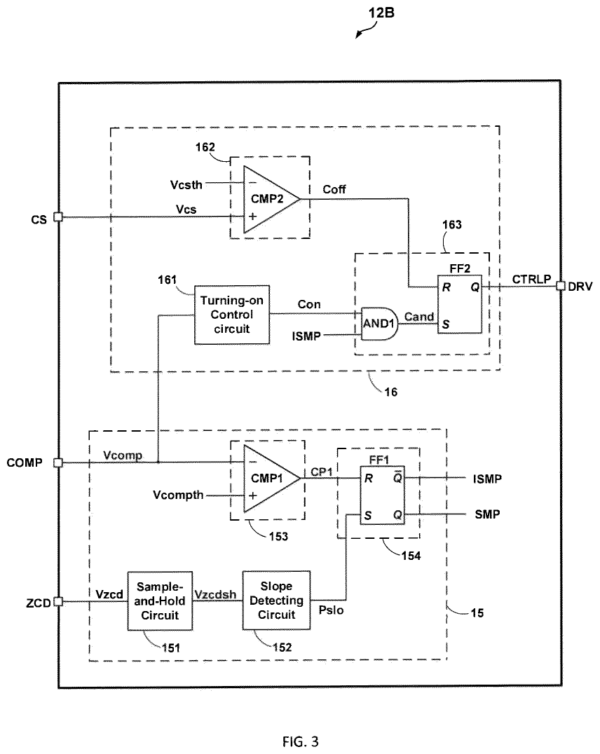

FIG. 3 illustrates a circuit schematic of a control circuit 12B used in the switching converter 200A with an embodiment of the present invention. As shown in FIG. 3, the control circuit 12B includes a sleep mode determining circuit 15 and a switch control circuit 16.

The sleep mode determining circuit 15 includes a sample-and-hold circuit 151, a slope detecting circuit 152, a first comparing circuit 153 and a first logic circuit 154.

The sample-and-hold circuit 151 is coupled to the zero-crossing detecting pin ZCD to receive the auxiliary winding voltage signal Vzcd and generates a sample-and-hold signal Vzcdsh based on the auxiliary winding voltage signal Vzcd.

The slope detecting circuit 152 detects the rising slope of the sample-and-hold signal Vzcdsh and generates a slope detecting signal Pslo based on the detection result. In one embodiment, the slope detecting circuit 152 detects whether the sample-and-hold signal Vzcdsh increases from a low value Vthl to a high value Vthh within a detect time threshold tth. If so, the slope detecting signal Pslo is valid (e.g., logic high). In another embodiment, the slope detecting circuit 152 compares the rising slope of the sample-and-hold signal Vzcdsh with a slope threshold. In response to the rising slope of the sample-and-hold signal Vzcdsh higher than the slope threshold, the slope detecting signal Pslo is valid. Those skilled in the art can understand that if the magnetic coupling between the auxiliary winding Aux and the secondary winding Sec of the switching converter 200A is changed, when the output voltage Vout increases sharply, the auxiliary winding voltage signal Vzcd decreases sharply. On this condition, the slope detecting circuit 152 can detect the falling slope of the sample-and-hold signal Vzcdsh to determine whether there is a sharp decrease in the auxiliary winding voltage signal Vzcd and generate the slope detecting signal Pslo based on the detection result.

The first comparing circuit 153 is coupled to the feedback pin COMP to receive the output feedback signal Vcomp and generates a first comparing signal CP1 by comparing the output feedback signal Vcomp with the feedback threshold Vcompth. In one embodiment, in response to the output feedback signal Vcomp decreasing to the feedback threshold Vcompth, the first comparing signal CP1 is valid (e.g., logic high). In one embodiment, the first comparing circuit 153 includes a first comparator CMP1.

The first logic circuit 154 receives the slope detecting signal Pslo and the first comparing signal CP1 and generates a sleep mode signal SMP based on the slope detecting signal Pslo and the first comparing signal CP1. In one embodiment, the first logic circuit 154 includes a first RS flip-flop FF1 having a set terminal S, a reset terminal R, an output terminal Q and an inverting output terminal ⁻Q. Where the set terminal S receives the slope detecting signal Pslo, the reset terminal R receives the first comparing signal CP1, the output terminal Q provides the sleep mode signal SMP and the inverting output terminal ⁻Q provides an inverting sleep mode signal ISMP. In one embodiment, in response to the sleep mode signal SMP valid (e.g., logic high), the control circuit 12B enters the sleep mode, the overload protection function is disabled.

The switch control circuit 16 includes a turning-on control circuit 161, a turning-off control circuit 162 and a second logic circuit 163.

The turning-on control circuit 161 is coupled to the feedback pin COMP to receive the output feedback signal Vcomp and generates a turning-on control signal Con to control the turning-on of the primary switch MP based on the output feedback signal Vcomp. In one embodiment, when the output feedback signal Vcomp increases, the frequency of the turning-on control signal Con increases; when the output feedback signal Vcomp decreases, the frequency of the turning-on control signal Con decreases.

The turning-off control circuit 162 is coupled to the current sensing pin CS to receive the primary current signal Vcs and generates a turning-off control signal Coff by comparing the primary current signal Vcs with a current threshold Vcsth. In one embodiment, in response to the primary current signal Vcs increasing to the current threshold Vcsth, the turning-off control signal Coff is valid (e.g., logic high). In one embodiment, the turning-off control circuit 162 includes a second comparator CMP2.

The second logic circuit 163 receives the turning-on control signal Con, the inverting sleep mode signal ISMP and the turning-off control signal Coff and generates the switch control signal CTRLP based on the turning-on control signal Con, the inverting sleep mode signal ISMP and the turning-off control signal Coff. In one embodiment, the second logic circuit 163 includes an AND gate AND1 and a second RS flip-flop FF2. The AND gate AND1 performs a logic AND operation on the inverting sleep mode signal ISMP and the turning-on control signal Con and generates an and signal Cand. The second RS flip-flop FF2 has a set terminal S, a reset terminal R and an output terminal Q, where the set terminal S receives the and signal Cand, the reset terminal R receives the turning-off control signal Coff and the output terminal Q provides the switch control signal CTRLP. In one embodiment, in response to the sleep mode signal SMP valid (e.g., logic high), the switch control signal CTRLP is logic low.

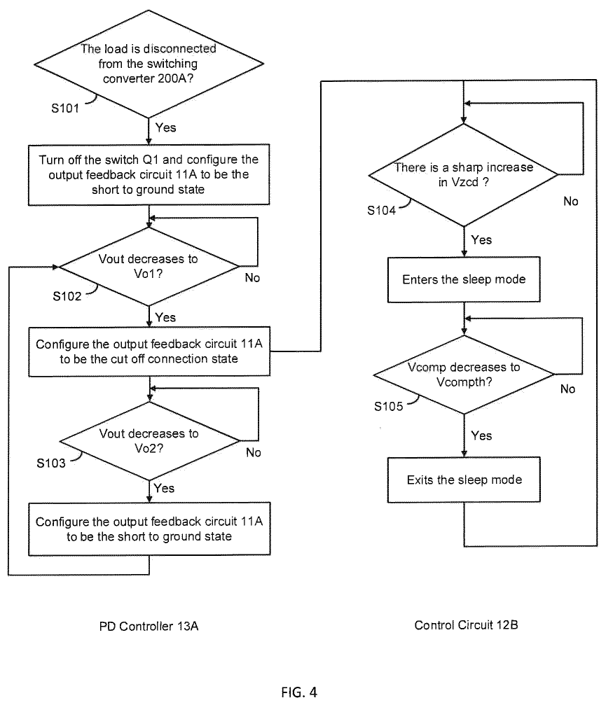

FIG. 4 illustrates a working flowchart of the control circuit 12B and a PD controller 13A during the time period when the load is disconnected from the switching converter 200A in accordance with an embodiment of the present invention. The working flowchart includes steps S101˜S105.

The PD controller 13A performs the steps S101˜S103. At step S101, it is detected whether the load is disconnected from the switching converter 200A. If yes, the switch Q1 is configured to be turned off and the output feedback circuit 11A is configured to be the short to ground state.

At step S102, it is detected whether the output voltage Vout decreases to the first output threshold Vo1. If yes, the output feedback circuit 11A is configured to be the cut off connection state.

At step S103, it is detected whether the output voltage Vout decreases to the second output threshold Vo2. If yes, the output feedback circuit 11A is configured to be the short to ground state.

The control circuit 12B performs the steps S104˜S105. At step S104, it is detected whether there is a sharp increase in the auxiliary winding voltage signal Vzcd. If yes, the control circuit 12B enters the sleep mode. In one embodiment, the control circuit 12B detects the sharp increase of the auxiliary winding voltage signal Vzcd by detecting whether the auxiliary winding voltage signal Vzcd increases from a low value to a high value within a detect time threshold. In another embodiment, the control circuit 12B detects the sharp increase of the auxiliary winding voltage signal Vzcd by comparing a slope of the auxiliary winding voltage signal Vzcd with a slope threshold.

At step S105, it is detected whether the output feedback signal Vcomp decreases to the feedback threshold Vcompth. If yes, the control circuit 12B exits the sleep mode.

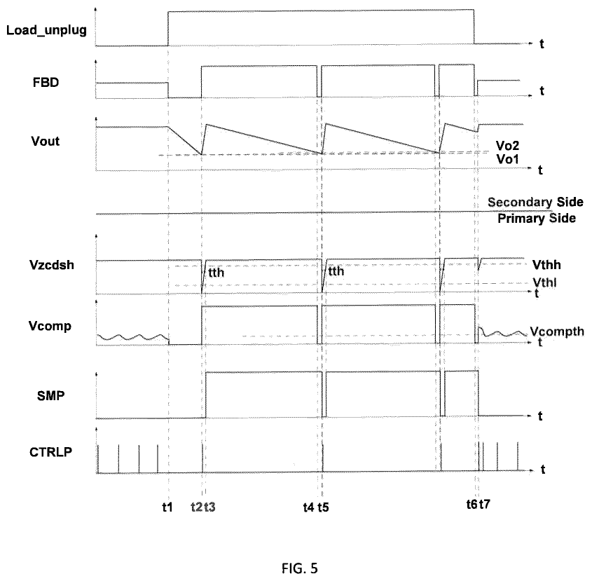

FIG. 5 illustrates a working waveform of the switching converter 200A in accordance with an embodiment of the present invention. The working principle of the switching converter 200A will be set forth referring to FIG. 2˜FIG. 5.

As shown in FIG. 5, before time t1, a load indicating signal Load_unplug is logic low, indicating that the load is connected to the switching converter 200A. The output feedback circuit 11A is configured to be the normal connection state, the output feedback signal Vcomp has a first state, the control circuit 12B operates in the normal work mode and the output voltage Vout keeps at the expected value.

At time t1, the load indicating signal Load_unplug changes from logic low to logic high, indicating that the load is disconnected from the switching converter 200A. The output feedback circuit 11A is configured to be the short to ground state and the output feedback signal Vcomp has the second state (e.g., the output feedback signal Vcomp reaches minimum). The switch control signal CTRLP keeps logic low and the output voltage Vout decreases.

At time t2, the output voltage Vout decreases to the first output threshold Vo1, the output feedback circuit 11A is configured to be the cut off connection state, the output feedback signal Vcomp has the third state (e.g., the output feedback signal Vcomp reaches maximum), the switch control signal CTRLP switches between logic low and logic high, the output voltage Vout increases sharply and the auxiliary winding voltage signal Vzcd also increases sharply.

At time t3, in response to the sharp increase of the auxiliary winding voltage signal Vzcd (e.g., the sample-and-hold signal Vzcdsh increases from the low value Vthl to the high value Vthh within the detect time threshold tth), the sleep mode signal SMP changes from logic low to logic high, the control circuit 12B enters the sleep mode. The switch control signal CTRLP keeps logic low and the output voltage Vout decreases.

At time t4, the output voltage Vout decreases to the second output threshold Vo2, the output feedback circuit 11A is configured to be the short to ground state, the output feedback signal Vcomp has the second state (e.g., the output feedback signal Vcomp reaches minimum). In response to the output feedback signal Vcomp decreasing to the feedback threshold Vcompth, the sleep mode signal SMP changes from logic high to logic low, the control circuit 12B exits the sleep mode. In the example shown in FIG. 5, in response to the time period when the output feedback signal Vcomp is lower than the feedback threshold Vcompth becoming longer than a feedback time threshold, the sleep mode signal SMP changes from logic high to logic low.

At time t5, the output voltage Vout decreases the first output threshold Vo1 again, the output feedback circuit 11A is configured to be the cut off connection state. The output feedback signal Vcomp has the third state (e.g., the output feedback signal Vcomp reaches maximum), the switch control signal CTRLP switches between logic low and logic high, the output voltage Vout increases sharply and the auxiliary winding voltage signal Vzcd also increases sharply. Then in response to the sharp increase of the auxiliary winding voltage signal Vzcd, the sleep mode signal SMP changes from logic low to logic high and the control circuit 12B enters the sleep mode again.

At time t6, the load indicating signal Load_unplug changes from logic high to logic low, indicating that the load is reconnected to the switching converter 200A, the output feedback circuit 11A is configured to be the short to ground state, the output feedback signal Vcomp has the second state (e.g., the output feedback signal Vcomp reaches minimum). In response to the output feedback signal Vcomp decreasing to the feedback threshold Vcompth, the sleep mode signal SMP changes from logic high to logic low and the control circuit 12B exits the sleep mode.

At time t7, the load indicating signal Load_unplug is logic low, indicating that the load is connected to the switching converter 200A normally, the output feedback circuit 11A is configured to be the normal connection state and the control circuit 12B operates in the normal work mode.

In the above embodiments, during the time period when the load is disconnected from the switching converter 200A, for most of the time, the output feedback circuit 11A is in the cut off connection state and the control circuit 12B is in the sleep mode. The power loss of the output feedback circuit 11A and the control circuit 12B decreases greatly and the switching converter 200A has extremely low no load power consumption.

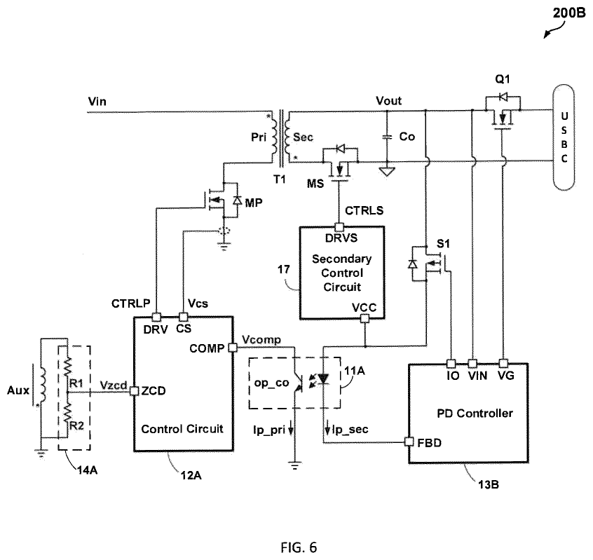

FIG. 6 illustrates a circuit schematic of a switching converter 200B in accordance with an embodiment of the present invention. Different from the switching converter 200A shown in FIG. 2, the switching converter 200B further includes a secondary control circuit 17 for controlling the secondary switch MS. The secondary control circuit 17 includes a driving pin DRVS and a power supply pin VCC. The secondary control circuit 17 provides a secondary control signal CTRLS to the secondary switch MS though the driving pin DRVS. The power supply pin VCC is coupled to the output voltage Vout and the secondary control circuit 17 is powered by the output voltage Vout.

In one embodiment, when the output feedback circuit 11A is configured to be the cut off connection state, the power supply pin VCC is configured to be disconnected from the output voltage Vout to further reduce the power loss. In the example shown in FIG. 6, the power supply pin VCC is coupled to the output voltage Vout through a switch S1 and is also coupled to the output feedback circuit 11A. The PD controller 13B can configure the output feedback circuit 11A to be the cut off connection state and disconnect the power supply pin VCC from the output voltage Vout by turning off the switch S1 through a pin IO.

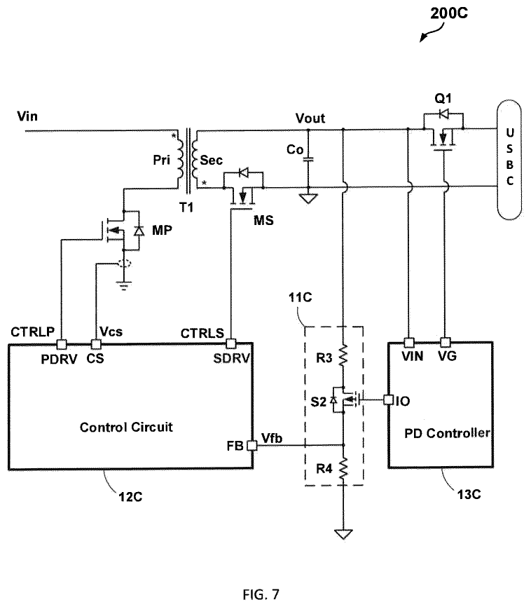

FIG. 7 illustrates a circuit schematic of a switching converter 200C in accordance with an embodiment of the present invention. The switching converter 200C includes a transformer T1, a primary switch MP, a secondary switch MS, an output capacitor Co, an output feedback circuit 11C, a control circuit 12C and a PD controller 13C connected as shown in FIG. 7.

The output feedback circuit 11C is coupled to an output voltage Vout and provides an output feedback signal Vfb. In the example shown in FIG. 7, the output feedback circuit 11C includes resistors R3 and R4.

The control circuit 12C integrates functions such as isolation control, primary control and secondary control into a single integrated circuit. The control circuit 12C has a plurality of pins, including a feedback pin FB, a secondary driving pin SDRV, a current sensing pin CS and a primary driving pin PDRV. The feedback pin FB is coupled to the output feedback circuit 11C to receive the output feedback signal Vfb. The current sensing pin CS is coupled to the primary switch MP to receive a primary current signal Vcs indicative of a current flowing through the primary switch MP. The primary driving pin PDRV and the secondary driving pin SDRV provides a switch control signal CTRLP and a secondary control signal CTRLS to the primary switch MP and the secondary switch MS respectively, thereby controlling the power operation of the switching converter 200C.

The PD controller 13C at secondary side includes a pin IO, a pin VIN and a pin VG. The pin IO is coupled to the output feedback circuit 11C and the PD controller 13C can configure the state of the output feedback circuit 11C through the pin IO. The pin VIN is coupled to the output voltage Vout and the PD controller 13C can detect the output voltage Vout through the pin VIN. The pin VG is coupled to a switch Q1 and the PD controller 13 can control the switch Q1 through the pin VG based on the power requirement of a USB port USBC.

In the example shown in FIG. 7, the output feedback circuit 11C further includes a switch S2. The PD controller 13C can configure the output feedback circuit 11C to be the normal connection state/the cut off connection state by turning on/turning off the switch S2 through the pin IO.

In one embodiment, during the time period when a load connected to the switching converter 200C, the PD controller 13C configures the output feedback circuit 11C to be the normal connection state and the output feedback signal Vfb has a first state (e.g., the output feedback signal Vfb can represent the output voltage Vout). The control circuit 12C operates in the normal work mode.

In one embodiment, during the time period when the load is disconnected from the switching converter 200C, the output feedback circuit 11C is configured to be the cut off connection state or the normal connection state. In response to the cut off connection state or the normal connection state of the output feedback circuit 11C, the control circuit 12C is configured to enter the sleep mode or exit the sleep mode.

In a further embodiment, during the time period when the load is disconnected from the switching converter 200C, in response to the output voltage Vout increases to a third output threshold Vo3, the PD controller 13C configures the output feedback circuit 11C to be the cut off connection state. The output feedback signal Vfb has a second state (e.g., the output feedback signal Vfb keeps zero). The switch control signal CTRLP keeps logic low. In response to the duration of the switch control signal CTRLP keeping logic low (i.e., the switching converter 200C stops switching) reaching a time threshold Tdet, the control circuit 12C enters the sleep mode.

In another further embodiment, during the time period when the load is disconnected from the switching converter 200C, in response to the output voltage Vout decreases to a fourth output threshold Vo4, the PD controller 13C configures the output feedback circuit 11C to be the normal connection state. The output feedback signal Vfb has the first state and the switch control signal CTRLP switches between logic low and logic high. The control circuit 12C exits the sleep mode.

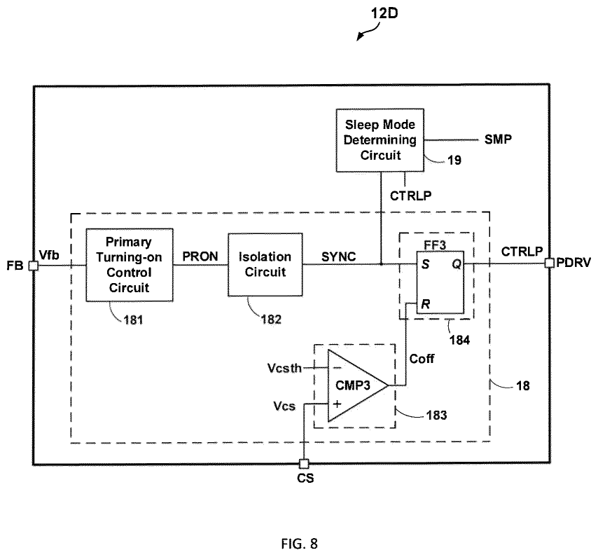

FIG. 8 illustrates a circuit schematic of a control circuit 12D used in the switching converter 200C in accordance with an embodiment of the present invention. As shown in FIG. 8, the control circuit 12D includes a switch control circuit 18 and a sleep mode determining circuit 19.

The switch control circuit 18 includes a primary turning-on control circuit 181, an isolation circuit 182, a turning-off control circuit 183 and a logic circuit 184.

The primary turning-on control circuit 181 is coupled to the feedback pin FB to receive the output feedback signal Vfb and generates a primary turning-on signal PRON based on the output feedback signal Vfb. In one embodiment, the output feedback signal Vfb decreases, the frequency of the primary turning-on signal PRON decreases.

The isolation circuit 182 receives the primary turning-on signal PRON and generates a sync signal pulse SYNC electrically from the primary turning-on signal PRON to control the turning-on of the primary switch MP.

The turning-off control circuit 183 is coupled to the current sensing pin CS to receive the primary current signal Vcs and generates a turning-off control signal Coff to control the turning-off of the primary switch MP by comparing the primary current signal Vcs with a current threshold Vcsth. In one embodiment, in response to the primary current signal Vcs increasing to the current threshold Vcsth, the turning-off control signal Coff is valid (e.g., logic high). In one embodiment, the turning-off control circuit 162 includes a third comparator CMP3.

The logic circuit 184 receives the sync signal pulse SYNC and the turning-off control signal Coff and generates the switch control signal CTRLP based on the sync signal pulse SYNC and the turning-off control signal Coff. In one embodiment, the logic circuit 184 includes a third RS flip-flop FF3 having a set terminal S, a reset terminal R and an output terminal Q, where the set terminal S receives the sync signal pulse SYNC, the reset terminal R receives the turning-off control signal Coff and the output terminal Q provides the switch control signal CTRLP.

The sleep mode determining circuit 19 generates the sleep mode signal SMP based on the sync signal pulse SYNC and the switch control signal CTRLP. In one embodiment, in response to the sync signal pulse SYNC appearing, the sleep mode signal SMP is invalid and the control circuit 12D exits the sleep mode. In one embodiment, in response to the duration of the switch control signal CTRLP keeping logic low reaching the time threshold Tdet, the sleep mode signal SMP is valid and the control circuit 12D enters the sleep mode. In one embodiment, when the sleep mode signal SMP is valid, the overload protection function is disabled.

Those skilled in the art can understand that the sleep mode determining circuit 19 can also generate the sleep mode signal SMP based on a single signal of the sync signal pulse SYNC and the switch control signal CTRLP. For example, in response to the switch control signal CTRLP switching between logic low and logic high, the sleep mode signal SMP is invalid. In response to the logic low duration of the switch control signal CTRLP reaching the time threshold Tdet, the sleep mode signal SMP is valid.

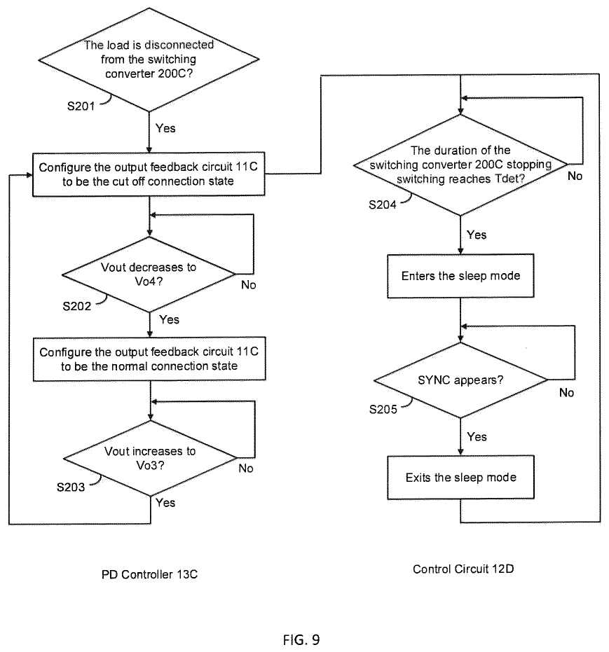

FIG. 9 illustrates a working flowchart of the control circuit 12D and a PD controller 13C during a time period when a load is disconnected from the switching converter 200C in accordance with an embodiment of the present invention. The working flowchart includes steps S201˜S205.

The PD controller 13C performs the steps S201˜S203. At step S201, it is detected whether the load is disconnected from the switching converter 200C. If yes, the output feedback circuit 11C is configured to be the cut off connection state.

At step S202, it is detected whether the output voltage Vout decreases to the fourth output threshold Vo4. If yes, the output feedback circuit 11C is configured to be the normal connection state.

At step S203, it is detected whether the output voltage Vout increases to the third output threshold Vo3. If yes, the output feedback circuit 11C is configured to be the cut off connection state.

The control circuit 12D performs the steps S204˜S205. At step S204, it is determined whether the duration of the switching converter 200C stopping switching reaches the time threshold Tdet. If yes, the control circuit 12D enters the sleep mode.

At step S205, it is detected whether the sync signal pulse SYNC appears. If yes, the control circuit 12D exits the sleep mode.

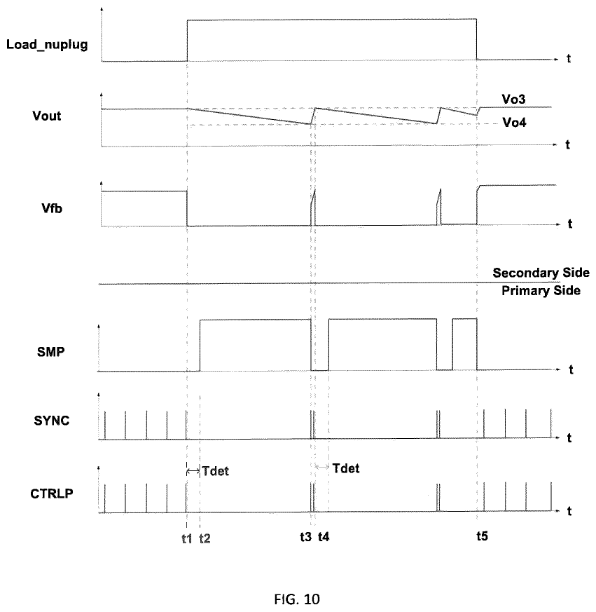

FIG. 10 illustrates a working waveform of the switching converter 200C in accordance with an embodiment of the present invention. The working principle of the switching converter 200C will be set forth referring to the FIG. 7˜FIG. 10.

As shown in FIG. 10, before time t1, the load indicating signal Load_unplug is logic low, indicating that the load is connected to the switching converter 200C normally. The output feedback circuit 11C is configured to be the normal connection state and the control circuit 12D operates in the normal work mode.

At time t1, the load indicating signal Load_unplug changes from logic low to logic high, indicating that the load is disconnected from the switching converter 200C. The output feedback circuit 11C is configured to be the cut off connection state, the output feedback signal Vfb has the second state (e.g., the output feedback signal Vfb keeps zero). The switch control signal CTRLP keeps logic low and the output voltage Vout decreases.

At time t2, the duration of the switching converter 200C stopping switching reaches the time threshold Tdet, the sleep mode signal SMP changes from logic low to logic high and the control circuit 12D enters the sleep mode.

At time t3, the output voltage Vout decreases to the fourth output threshold Vo4, the output feedback circuit 11C is configured to be the normal connection state and the output feedback signal Vfb has the first state. The sync signal pulse SYNC appears, the sleep mode signal SMP changes from logic high to logic low and the control circuit 12D exits the sleep mode. The switch control signal CTRLP switches between logic low and logic high and the output voltage Vout increases.

At time t4, the output voltage Vout increases to the third output threshold Vo3, the output feedback circuit 11C is configured to be the cut off connection state and the output feedback signal Vfb has the second state. The switch control signal CTRLP keeps logic low and the output voltage Vout decreases. After the duration of the switching converter 200C stopping switching reaches the time threshold Tdet, the sleep mode signal SMP changes from logic low to logic high and the control circuit 12D enters the sleep mode again.

At time t5, the load indicating signal Load_unplug changes from logic high to logic low, indicating that the load is reconnected to the switching converter 200C. The output feedback circuit 11C is configured to be the normal connection state and the control circuit 12D operates in the normal work mode.

According to the embodiments of the present invention, during the time period when the load is disconnected from the switching converter, for most of the time, the output feedback circuit is configured to be the cut off connection state and the control circuit operates in the sleep mode, thus the power loss is reduced and the switching converter has extremely low no load power consumption.

In the examples shown above, the PD controller is used to detect the load, to detect the output voltage and to configure the state of the output feedback circuit. However, those skilled in the art can understand that the PD controller is exemplary illustration, other suitable circuits are also applicable here, as long as these circuits can detect whether the load is disconnected from the switching converter, detect the output voltage and configure the state of the output feedback circuit.

FIG. 11 illustrates a circuit schematic of a switching converter 300 in accordance with an embodiment of the present invention. The switching converter 300 includes a voltage converting circuit 31 and a control circuit 32.

The voltage converting circuit 31 is configured to convert an input voltage Vin into an output voltage Vout. The voltage converting circuit 31 includes a transformer T1, a primary switch MP, a secondary switch MS and an output capacitor Co. The transformer T1 has a primary winding Pri and a secondary winding Sec, where both the primary winding Pri and the secondary winding Sec have a first terminal and a second terminal. The first terminal of the primary winding Pri is coupled to receive the input voltage Vin. The primary switch MP is coupled between the second terminal of the primary winding Pri and a primary reference ground. The first terminal of the secondary winding Sec is coupled to provide the output voltage Vout. The secondary switch MS is coupled between the second terminal of the secondary winding Sec and a secondary reference ground. The voltage across the output capacitor Co is the output voltage Vout. Those skilled in art can understand that the secondary switch MS can also be coupled between the first terminal of the secondary winding Sec and the output capacitor Co.

The control circuit 32 is configured to control the power operation of the voltage converting circuit 31. The control circuit 32 has a plurality of pins, including a feedback pin FB, a secondary driving pin SDRV, a secondary ground pin SVSS, a primary ground pin PVSS and a primary driving pin PDRV. The feedback pin FB is operable to be coupled to a PD controller, a MCU (Microcontroller Unit) or other circuits. The PD controller or MCU can change a voltage at the feedback pin FB to inform the control circuit 32 to enter a low power mode from a normal power mode or inform the control circuit 32 to exit the low power mode and enter the normal power mode. In one embodiment, The PD controller or MCU can change the voltage at the feedback pin FB (feedback voltage) based on a load condition of the switching converter 300, i.e., the feedback voltage can indicate the load condition. The secondary driving pin SDRV is configured to provide a secondary switch control signal CTRLS to control the secondary switch MS. The secondary ground pin SVSS is coupled to the secondary reference ground. The primary driving pin PDRV is configured to provide a primary switch control signal CTRLP to control the primary switch MP. The primary ground pin PVSS is coupled to the primary reference ground.

The control circuit 32 includes a secondary control circuit 33 which is coupled to the secondary reference ground and a primary control circuit 34 which is coupled to the primary reference ground. In the example shown in FIG. 11, the control circuit 32 further includes an isolation circuit 323 for isolating the primary control circuit 34 from the secondary control circuit 33. In one embodiment, the isolation circuit 323 includes a capacitor. In other embodiments, the isolation circuit 323 includes opto-couplers, transformers or other suitable isolation devices.

The secondary control circuit 33 includes a secondary sensing circuit 321 and a transmitter 322. The secondary sensing circuit 321 is coupled to the feedback pin FB and configured to detect the voltage at the feedback pin FB to generate a secondary low power mode signal LPS. The secondary control circuit 33 determines whether to enter the low power mode from the normal power mode or whether to exit the low power mode based on the secondary low power mode signal LPS (i.e., based on the voltage at the feedback pin FB). In one embodiment, the voltage at the feedback pin FB (feedback voltage) can indicate the load condition. In one embodiment, when the secondary sensing circuit 321 detects that the voltage at the feedback pin FB satisfies a low power entering condition, for example, the voltage at the feedback pin FB is lower than a first feedback threshold Vth1, the secondary control circuit 33 enters the low power mode from the normal power mode; when the secondary sensing circuit 321 detects that the voltage at the feedback pin FB satisfies a low power exiting condition, for example, the voltage at the feedback pin FB is higher than a second feedback threshold Vth2, the secondary control circuit 33 exits the low power mode and enters the normal power mode.

In one embodiment, when the secondary control circuit 33 is in the low power mode, the secondary sensing circuit 321 remains enabled, while the transmitter 322 and other modules (such as a secondary switch control circuit (not shown in FIG. 11)) of the secondary control circuit 33 are disabled. The power consumption of transmitter 322 is relatively high while the secondary sensing circuit 321 has low power consumption. Disabling the transmitter 322 can help reduce the power consumption of the switching converter 300.

In one embodiment, when the secondary control circuit 33 is determined to exit the low power mode and enter the normal power mode, the secondary control circuit 33 is configured to provide a secondary switch control signal CTRLS having valid state (e.g., logical high) to turn on the secondary switch MS. Then the primary control circuit 34 can detect the valid secondary switch control signal CTRLS and determine whether to exit the low power mode and to enter the normal power mode based on the detection result, which will be described later. In one embodiment, when the secondary control circuit 33 is in the normal power mode, the transmitter 322 and other modules of the secondary control circuit 33 are enabled.

The transmitter 322 is configured to be enabled when the secondary control circuit 33 is in the normal power mode and configured to be disabled when the secondary control circuit 33 is in the low power mode. When the transmitter 322 is enabled, the transmitter 322 modulates a secondary sync signal SyncS and transmits the modulated secondary sync signal to the primary control circuit 34. When the transmitter 322 is disabled, the transmitter 322 stops modulating the secondary sync signal SyncS and transmitting the modulated secondary sync signal. In one embodiment, the secondary sync signal SyncS is generated based on an output feedback signal indicative of the output voltage Vout. In one embodiment, the transmitter 322 is a modulator and includes a high-frequency oscillator, which has high power consumption.

The primary control circuit 34 includes a receiver 324 and a timer 325. The receiver 324 is configured to be enabled when the primary control circuit 34 is in the normal power mode and configured to be disabled when the primary control circuit 34 is in the low power mode. When the receiver 324 is enabled, the receiver 324 is configured to demodulate the modulated secondary sync signal sent from the transmitter 322 and to generate a primary sync signal SyncP to control the primary switch MP. In one embodiment, the primary control circuit 34 is configured to generate the primary switch control signal CTRLP to control the primary switch MP based on the primary sync signal SyncP. In one embodiment, the receiver 324 is a demodulator which has high power consumption.

The timer 325 is coupled to the receiver 324 and times a duration during which the receiver 324 fails to receive the modulated secondary sync signal sent from the transmitter 322 and generates a primary low power entering signal LPP1. The primary control circuit 34 determines whether to enter the low power mode from the normal power mode based on the primary low power entering signal LPP1(i.e., based on the duration during which the receiver 324 fails to receive the modulated secondary sync signal). In one embodiment, when the receiver 324 does not receive the modulated secondary sync signal, the timer 325 starts timing. Once the timed duration exceeds a duration threshold Tth, it is determined that the secondary control circuit 33 has entered the low power mode, the primary control circuit 34 is configured to enter the low power mode.

In one embodiment, when the primary control circuit 34 is in the low power mode, a primary sensing circuit (not shown in FIG. 11) for the primary control circuit 34 to determine whether to exit the low power mode remains enabled, while the receiver 324 and other modules (such as the timer 325 and a primary switch control circuit (not shown in FIG. 11)) for generating the primary switch control signal CTRLP) of the primary control circuit 34 are disabled. The power consumption of the receiver 324 is relatively high. Disabling the receiver 324 can help reduce the power consumption of the switching converter 300.

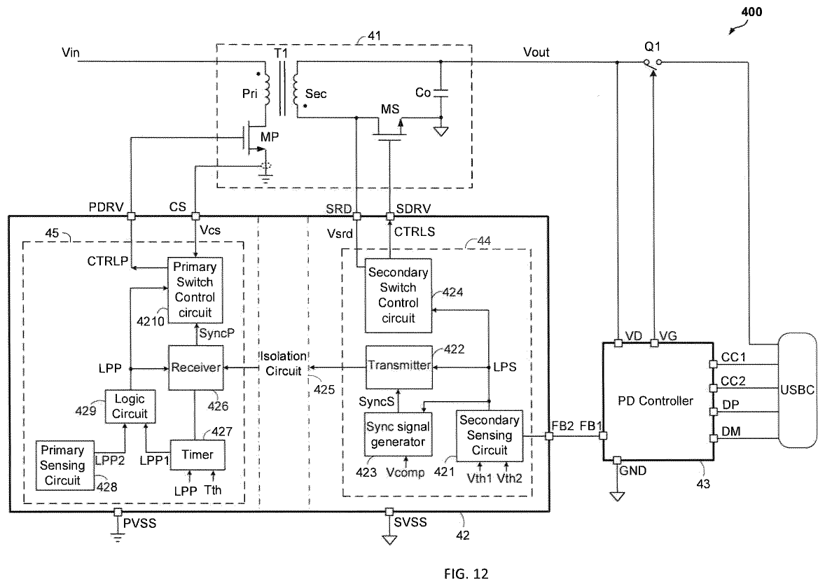

FIG. 12 illustrates a circuit schematic of a switching converter 400 in accordance with an embodiment of the present invention. The switching converter 400 includes a voltage converting circuit 41, a control circuit 42 and a PD controller 43.

The voltage converting circuit 41 is similar as the voltage converting circuit 31 and is configured to convert an input voltage Vin into an output voltage Vout.

The PD controller 43 has a plurality of pins, including a ground pin GND, a voltage detecting pin VD, load detecting pins CC1, CC2, DP and DM, a switch control pin VG and a feedback pin FB1. The ground pin GND is coupled to the secondary reference ground. The PD controller 43 is configured to detect the output voltage Vout through the voltage detecting pin VD and to detect whether a load (not shown) is connected to a USB port USBC through the load detecting pins CC1, CC2, DP, and DM. The PD controller 43 is further configured to control a switch Q1 through the switch control pin VG. In one embodiment, when the load is detected being disconnected from the USB port USBC, the PD controller 43 turns off the switch Q1.

The feedback pin FB1 is coupled to the control circuit 42. A voltage at the feedback FB1 is configured to be changed when the load or the output voltage Vout satisfies some conditions. In one embodiment, when the PD controller 43 detects that the load is disconnected from the USB port USBC, the voltage at the feedback pin FB1 will be pulled low; when the PD controller 43 detects that the load is reconnected to the USB port USBC, the voltage at the feedback pin FB1 will be pulled high. In another embodiment, during the time period when the load is disconnected from the USB port USBC, when the PD controller 43 detects that the output voltage Vout increases to a third output threshold Vo3, the voltage at the feedback pin FB1 will be pulled low; when the PD controller 43 detects that the output voltage Vout decreases to a fourth output threshold Vo4, the voltage at the feedback pin FB1 will be pulled high.

The control circuit 42 is configured to control the power operation of the voltage converting circuit 41. The control circuit 42 has a plurality of pins, including a feedback pin FB2, a secondary driving pin SDRV, a drain voltage detecting pin SRD, a secondary ground pin SVSS, a current sensing pin CS, a primary driving pin PDRV and a primary ground pin PVSS. The feedback pin FB2 is coupled to the feedback pin FB1 of the PD controller 43. The secondary driving pin SDRV is configured to provide a secondary switch control signal CTRLS to control the secondary switch MS. The drain voltage detecting pin SRD is coupled to the secondary switch MS to receive a drain voltage Vsrd of the secondary switch MS. The secondary ground pin SVSS is coupled to the secondary reference ground. The current sensing pin CS is coupled to the primary switch MP to receive a current sensing signal Vcs indicative of a current flowing through the primary switch MP. The primary driving pin PDRV is configured to provide a primary switch control signal CTRLP to control the primary switch MP. The primary ground pin PVSS is coupled to the primary reference ground.

In the example shown in FIG. 12, the control circuit 42 includes a secondary control circuit 44 and a primary control circuit 45. Where the secondary control circuit 44 includes a secondary sensing circuit 421, a transmitter 422, a sync signal generator 423 and a secondary switch control circuit 424. The primary control circuit 45 includes a receiver 426, a timer 427, a primary sensing circuit 428, a logic circuit 429 and a primary switch control circuit 4210. The control circuit 42 further includes an isolation circuit 425 for isolating the primary control circuit 45 from the secondary control circuit 44.

The secondary sensing circuit 421 is coupled to the feedback pin FB2 and is configured to detect the voltage at the feedback pin FB2 to generate a secondary low power mode signal LPS. The secondary control circuit 44 determines whether to enter the low power mode from the normal power mode or whether to exit the low power mode and enter the normal power mode based on the secondary low power mode signal LPS. In one embodiment, when the secondary sensing circuit 421 detects that the voltage at the feedback pin FB2 is lower than the first feedback threshold Vth1, the secondary control circuit 44 is configured to enter the low power mode; when the secondary sensing circuit 421 detects that the voltage at the feedback pin FB2 is higher than the second feedback threshold Vth2, the secondary control circuit 44 is configured to exit the low power mode.

In one embodiment, when the secondary control circuit 44 is in the low power mode, the secondary sensing circuit 421 remains enabled, while the transmitter 422 and other modules (such as the sync signal generator 423 and the secondary switch control circuit 424) of the secondary control circuit 44 are disabled. Disabling the transmitter 422 and other modules can help reduce the power consumption of the switching converter 400.

The transmitter 422 is configured to be enabled when the secondary control circuit 44 is in the normal power mode and to be disabled when the secondary control circuit 44 is in the low power mode. When the transmitter 422 is enabled, the transmitter 422 is configured to modulate a secondary sync signal SyncS and to transmit the modulated secondary sync signal to the primary control circuit 45. In the example shown in FIG. 12, the secondary sync signal SyncS is provided by the sync signal generator 423 based on a compensating signal Vcomp. Where the compensating signal Vcomp represents a difference between a reference voltage and an output feedback signal indicative of the output voltage Vout.

The secondary switch control circuit 424 is configured to be enabled when the secondary control circuit 44 is in the normal power mode and to be disabled when the secondary control circuit 44 is in the low power mode. When the secondary switch control circuit 424 is enabled, the secondary switch control circuit 424 generates the secondary switch control signal CTRLS based on the drain voltage Vsrd of the secondary switch MS.

The isolation circuit 425 is coupled between the transmitter 422 and the receiver 426.

The receiver 426 is configured to be enabled when the primary control circuit 45 is in the normal power mode and to be disabled when the primary control circuit 45 is in the low power mode. When the receiver 426 is enabled, the receiver 426 is configured to demodulate the modulated secondary sync signal sent from the transmitter 422 and to generate a primary sync signal SyncP based on the demodulated signal.

The timer 427 is coupled to the receiver 426 and times a duration during which the receiver 426 fails to receive the modulated secondary sync signal and generates the primary low power entering signal LPP1. The primary control circuit 45 determines whether to enter the low power mode from the normal power mode based on the primary low power entering signal LPP1.

In one embodiment, when the primary control circuit 45 is in the low power mode, the primary sensing circuit 428 remains enabled, while the receiver 426 and other modules (such as the timer 427 and the primary switch control circuit 4210) of the primary control circuit 45 are disabled. Disabling the receiver 426 and other modules can help reduce the power consumption of the switching converter 400.

The primary sensing circuit 428 is configured to generate a primary low power exiting signal LPP2. The primary control circuit 45 determines whether to exit the low power mode based on the primary low power exiting signal LPP2. In one embodiment, when the secondary control circuit 44 is determined to exit the low power mode, a secondary switch control signal CTRLS having valid state is provided to turn on the secondary switch MS. The primary control circuit 45 is configured to determine whether to exit the low power mode by detecting whether the secondary switch MS is turned on. The embodiments of the present invention provide multiple schemes for the primary sensing circuit 428 to detect whether the secondary switch MS is turned on, which will be described in detail below. The different schemes can help cover different application scenarios.

In one embedment, when the primary control circuit 45 is in the normal power mode, the receiver 426 and other modules of the primary control circuit 45 are enabled.

The logic circuit 429 is coupled to the timer 427 and the primary sensing circuit 428 and provides the primary low power mode signal LPP based on the primary low power entering signal LPP1 and the primary low power exiting signal LPP2.

The primary switch control circuit 4210 is configured to be enabled when the primary control circuit 45 is in the normal power mode and to be disabled when the primary control circuit 45 is in the low power mode. When the primary switch control circuit 4210 is enabled, the primary switch control circuit 4210 receives the primary sync signal SyncP and the current sensing signal Vcs and generates the primary switch control signal CTRLP to control the primary switch MP based on the primary sync signal SyncP and the current sensing signal Vcs.

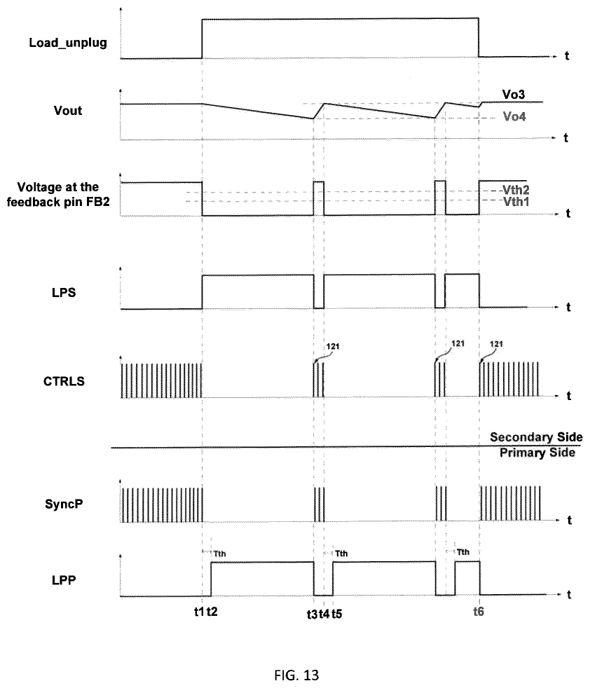

FIG. 13 illustrates a working waveform of the switching converter 400 in accordance with an embodiment of the present invention. As shown in FIG. 13, at time t1, the PD controller 43 detects that the load is disconnected from the USB port USBC (e.g., the load indicating signal Load_unplug changes from logical low to logical high, indicating that the load is disconnected from the USB port USBC), the voltage at the feedback pin FB1 is pulled low.

The voltage at the feedback pin FB2 also decreases in response to the voltage at the feedback pin FB1 being pulled low. When the secondary sensing circuit 421 detects that the voltage at the feedback pin FB2 is lower than the first feedback threshold Vth1, the secondary low power mode signal LPS changes from logical low to logical high and the secondary control circuit 44 enters the low power mode from the normal power mode. The secondary sensing circuit 421 remains enabled, while the transmitter 422 and other modules of the secondary control circuit 44 are disabled. Since the transmitter 422 is disabled, the receiver 426 cannot receive the modulated secondary sync signal sent from the transmitter 422.

At time t2, the receiver 426 fails to receive the modulated secondary sync signal for a duration exceeding the duration threshold Tth, the primary low power mode signal LPP changes from logical low to logical high and the primary control circuit 45 enters the low power mode from the normal power mode. The primary sensing circuit 428 remains enabled, while the receiver 426 and other modules of the primary control circuit 45 are disabled. According to the embodiments of the present invention, the transmitter 422 is disabled when the secondary control circuit 44 is in the low power mode and the receiver 426 is disabled when the primary control circuit 45 is in the low power mode. This can reduce the power consumption of the switching converter 400.

At time t3, the PD controller 43 detects that the output voltage Vout decreases to the fourth output threshold Vo4, the voltage at the feedback pin FB1 is pulled high. The voltage at the feedback pin FB2 also increases in response to the voltage at the feedback pin FB1 being pulled high. When the secondary sensing circuit 421 detects that the voltage at the feedback pin FB2 is higher than the second voltage Vth2, the secondary low power mode signal LPS changes from logical high to logical low, and the secondary control circuit 44 exits the low power mode and enters the normal power mode. The transmitter 422 and other modules of the secondary control circuit 44 are enabled. The transmitter 422 transmits the modulated secondary sync signal and attempts to re-establish communication with the primary control circuit 45. The secondary control circuit 44 further provides the secondary switch control signal CTRLS having valid state (see FIGS. 13, 121) to turn on the secondary switch MS.

Then the valid secondary switch control signal CTRLS is detected by the primary sensing circuit 428, the primary low power mode signal LPP changes from logical high to logical low, and the primary control circuit 45 exits the low power mode and enters the normal power mode. The receiver 426 and other modules of the primary control circuit 45 are enabled. Then the receiver 426 can receive the modulated secondary sync signal sent from the transmitter 422 and communicate normally with the secondary control circuit 44. The primary switch MP is controlled to be switched between ON and OFF, and the output voltage Vout increases.

At time t4, the PD controller 43 detects that the output voltage Vout increases to the third output threshold Vo3, the voltage at the feedback pin FB1 is pulled low. When the secondary sensing circuit 421 detects that the voltage at the feedback pin FB2 is lower than the first feedback threshold Vth1, the secondary control circuit 44 enters the low power mode. The transmitter 422 is disabled and the receiver 426 cannot receive the modulated secondary sync signal sent from the transmitter 422.

At time t5, the receiver 426 fails to receive the modulated secondary sync signal for the duration exceeding the duration threshold Tth, the primary control circuit 45 enters the low power mode.

At time t6, the PD controller 43 detects that the load is reconnected to the USB port USBC (e.g., the load indicating signal Load_unplug changes from logical high to logical low, indicating that the load is reconnected to the USB port USBC), the voltage at the feedback pin FB1 is pulled high. Then the secondary sensing circuit 421 detects that the voltage at the feedback pin FB2 is higher than the second voltage Vth2, the secondary control circuit 44 exits the low power mode and the transmitter 422 is enabled in an attempt to re-establish communication with the primary control circuit 45. The secondary control circuit 44 also provides the secondary switch control signal CTRLS having valid state (see FIGS. 13, 121) to turn on the secondary switch MS.

The valid secondary switch control signal CTRLS is detected by the primary sensing circuit 428 and the primary control circuit 45 is configured to exit the low power mode. The receiver 426 and other modules of the primary control circuit 45 are enabled. Then the receiver 426 can receive the modulated secondary sync signal sent from the transmitter 422, and the primary control circuit 45 can communicate normally with the secondary control circuit 44. The control circuit 42 operates in the normal work mode and the output voltage Vout is regulated to the expected value.

According to the embodiment of the present invention, during the time period when the load is disconnected from the switching converter 400, for most of the time, the transmitter 422 and the receiver 426 are both disabled. This can help reduce the power consumption of the switching converter 400.

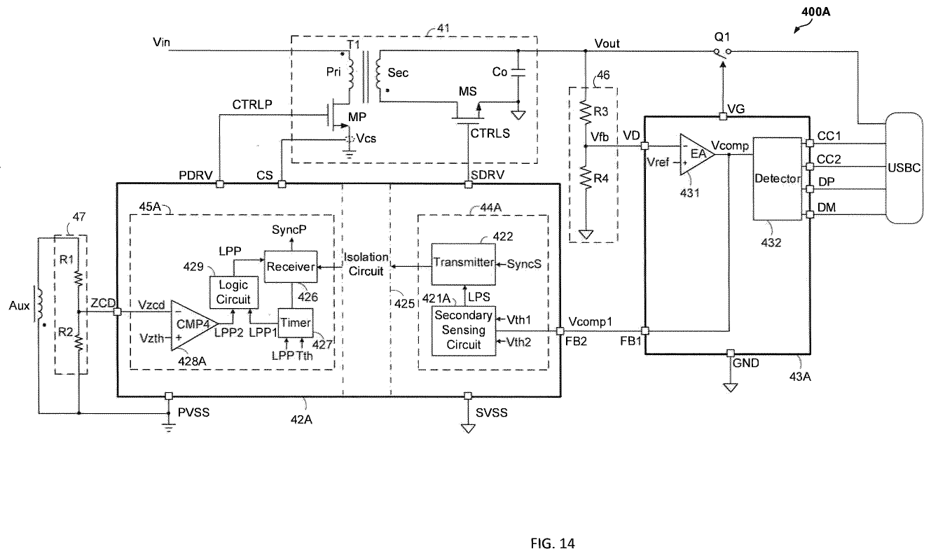

FIG. 14 illustrates a circuit schematic of a switching converter 400A in accordance with another embodiment of the present invention. Different from the switching converter 400 shown in FIG. 12, the switching converter 400A further includes an output feedback circuit 46. The output feedback circuit 46 is coupled to receive the output voltage Vout and provides the output feedback signal Vfb indicative of the output voltage Vout. In the example shown in FIG. 14, the output feedback circuit 46 includes resistors R3 and R4.

The PD controller 43A includes an error amplifying circuit 431 and a detector 432. The error amplifying circuit 431 is coupled to the output feedback circuit 46 through the voltage detecting pin VD to receive the output feedback signal Vfb and generates a compensating signal Vcomp based on a difference between a reference voltage Vref and the output feedback signal Vfb. In one embodiment, when the output voltage Vout increases, the compensating signal Vcomp will decrease; when the output voltage Vout decreases, the compensating signal Vcomp will increase.

The detector 432 is coupled to the load detecting pins CC1, CC2, DP and DM to detect whether the load is connected to the USB port USBC.

In one embodiment, when the detector 432 detects the load is disconnected from the USB port USBC, the PD controller 43A is configured to pull the voltage at the feedback pin FB1 low; when the detector 432 detects the load is reconnected to the USB port USBC, the PD controller 43A is configured to pull the voltage at the feedback pin FB1 high. The voltage at the feedback pin FB1 can indicate the load condition of the switching converter 400A.

The feedback pin FB1 is coupled to the feedback pin FB2 of the control circuit 42A. The secondary control circuit 44A determines whether to enter or exit the low power mode based on the voltage Vcomp1 at the feedback pin FB2. In one embodiment, the voltage at the feedback pin FB2 can indicate the load condition of the switching converter 400A.

When the secondary sensing circuit 421A detects that the voltage Vcomp1 at the feedback pin FB2 is lower than the first feedback threshold Vth1, the secondary control circuit 44A enters the low power mode. When the secondary sensing circuit 421A detects that the voltage Vcomp1 at the feedback pin FB2 is higher than the second feedback threshold Vth2, the secondary control circuit 44A exits the low power mode and enters the normal power mode.

The sync signal generator 423, the secondary switch control circuit 424 and the primary switch control circuit 4210 shown in FIG. 12 are not shown in FIG. 14 for clarity. The working principles of the transmitter 422, the isolation circuit 425, the receiver 426, the timer 427 and the logic circuit 429 in FIG. 14 are similar with the example shown in FIG. 12, thus are omitted for clarity.

Different from the control circuit 42 shown in FIG. 12, the control circuit 42A shown in FIG. 14 further includes a zero-crossing detecting pin ZCD. The zero-crossing detecting pin ZCD is coupled to an auxiliary winding Aux of the transformer T1 to detect a voltage across the auxiliary winding Aux. In the example shown in FIG. 14, the zero-crossing detecting pin ZCD is coupled to the auxiliary winding Aux through an auxiliary voltage detecting circuit 47. The auxiliary voltage detecting circuit 47 provides an auxiliary winding voltage signal Vzcd indicative of the voltage across the auxiliary winding Aux and includes resistors R1 and R2.

The primary sensing circuit 428A is coupled to the zero-crossing detecting pin ZCD and is configured to detect the valid secondary switch control signal CTRLS based on the auxiliary winding voltage signal Vzcd. In one embodiment, the primary sensing circuit 428A includes a comparator CMP4, which has low power consumption.

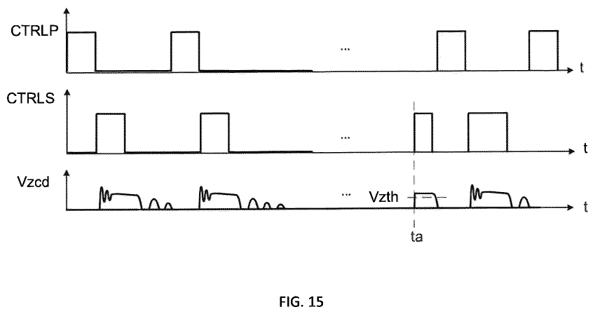

FIG. 15 illustrates a working waveform of the switching converter 400A in accordance with an embodiment of the present invention. As shown in FIG. 15, when the primary switch MP is turned on (e.g., the primary switch control signal CTRLP is logical high), the auxiliary winding voltage signal Vzcd is zero substantially. When the primary switch MP is turned off (e.g., the primary switch control signal CTRLP is logical low) and the secondary switch MS is turned on (e.g., the secondary switch control signal CTRLS is logical high), the auxiliary winding voltage signal Vzcd will increase.

When the primary control circuit 45A is in the low power mode, the primary sensing circuit 428A is enabled with low power consumption. At time ta, the secondary control circuit 44A exits the low power mode and provides the secondary switch control signal CTRLS in logical high to turn on the secondary switch MS. In response to the secondary switch MS being turned on, the auxiliary winding voltage signal Vzcd increases. Then the primary sensing circuit 428A detects that the auxiliary winding voltage signal Vzcd is higher than a threshold Vzth, it is determined that the secondary control circuit 44A has exited the low power mode, the primary control circuit 45A is configured to exit the low power mode.

In another embodiment, the magnetic coupling between the auxiliary winding Aux and the secondary winding Sec is contrary to the example shown in FIG. 14, when the primary sensing circuit 428A detects the auxiliary winding voltage signal Vzcd being lower than a threshold, it is determined that the secondary control circuit 44A has exited the low power mode, the primary control circuit 45A is configured to exit the low power mode.

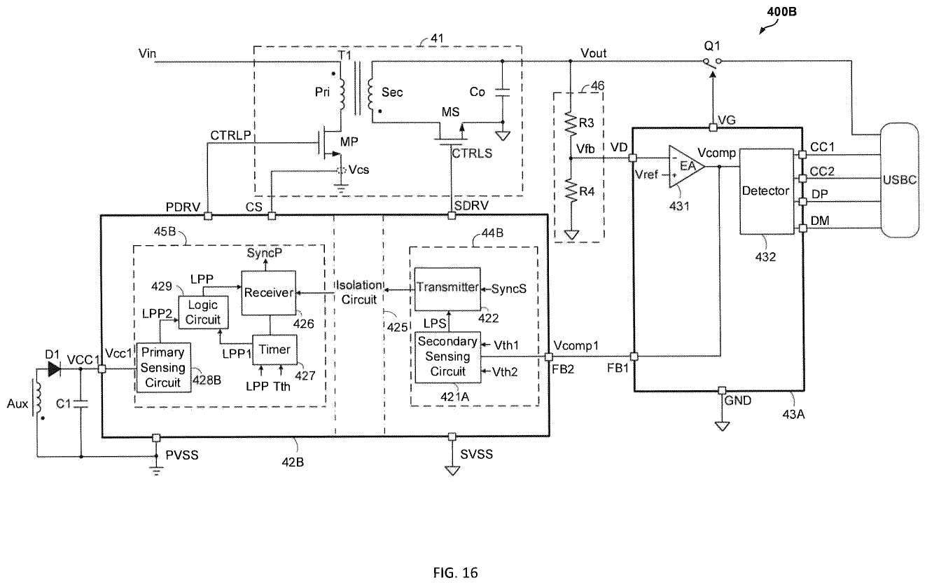

FIG. 16 illustrates a circuit schematic of a switching converter 400B in accordance with an embodiment of the present invention. Different from the control circuit 42A shown in FIG. 14, the control circuit 42B shown in FIG. 16 includes a power supply pin VCC1 coupled to the auxiliary winding Aux through a unidirectional device and providing a supply voltage to the primary control circuit 45B.

As shown in FIG. 16, the switching converter 400B further includes a unidirectional device D1 and a capacitor C1. The auxiliary winding Aux has a first terminal and a second terminal. The unidirectional device D1 has an anode and a cathode, where the anode is coupled to the first terminal of the auxiliary winding Aux. The capacitor C1 has a first terminal and a second terminal, where the first terminal is coupled to the cathode of the unidirectional device D1 and the second terminal is coupled to the second terminal of the auxiliary winding Aux. The capacitor C1 is configured to provide a supply voltage Vcc1 through the power supply pin VCC1 to power the primary control circuit 45B.

The primary sensing circuit 428B is coupled to the power supply pin VCC1 and is configured to detect the valid secondary switch control signal CTRLS based on the supply voltage Vcc1.

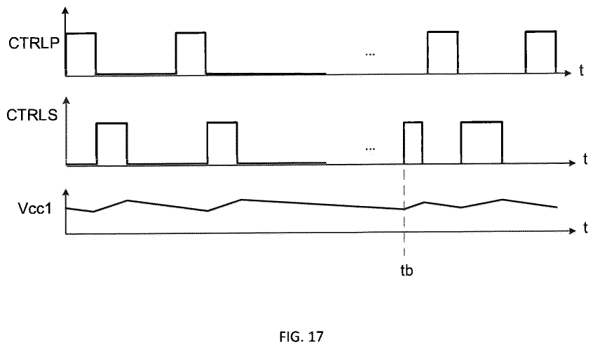

FIG. 17 illustrates a working waveform of the switching converter 400B in accordance with an embodiment of the present invention. As shown in FIG. 17, when the secondary switch MS turns on, the auxiliary winding Aux charges capacitor C1 and the supply voltage Vcc1 increases.

When the primary control circuit 45B is in the low power mode, the primary sensing circuit 428B is enabled with low power consumption. As no current flows into C1, the supply voltage Vcc1 drops gradually. At time tb, the secondary control circuit 44B exits the low power mode and provides the secondary switch control signal CTRLS having valid state to turn on the secondary switch MS. In response to the secondary switch MS being turned on, the auxiliary winding Aux will charge the capacitor C1, making the supply voltage Vcc1 shift from a slow decline to a rapid rise. The primary sensing circuit 428B detects the voltage trend change at the supply voltage Vcc1, it is determined that the secondary control circuit 44B has exited the low power mode, the primary control circuit 45B is configured to exit the low power mode.

In one embodiment, during the time period when the primary control circuit 45B is in the low power mode, when the primary sensing circuit 428B detects that the supply voltage Vcc1 increases to a threshold, it is determined that the secondary control circuit 44B has exited the low power mode, the primary control circuit 45B is configured to exit the low power mode. The value of the threshold can be set based on practical application.

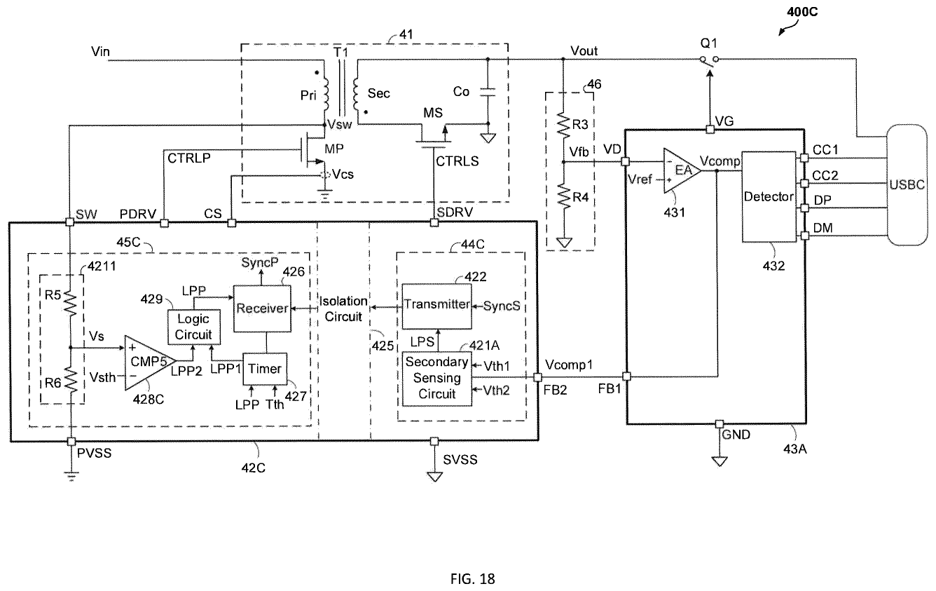

FIG. 18 illustrates a circuit schematic of a switching converter 400C in accordance with an embodiment of the present invention. Different from the switching converter 400A shown in FIG. 14, the switching converter 400C does not include the auxiliary winding Aux, which can help make the entire system more compact. As shown in FIG. 18, the control circuit 42C includes a switching pin SW coupled to the primary switch MP to receive a switching voltage Vsw (i.e., the drain voltage of the primary switch MP). The primary sensing circuit 428C is coupled to the switching pin SW and configured to detect the valid secondary switch control signal CTRLS based on the switching voltage Vsw.

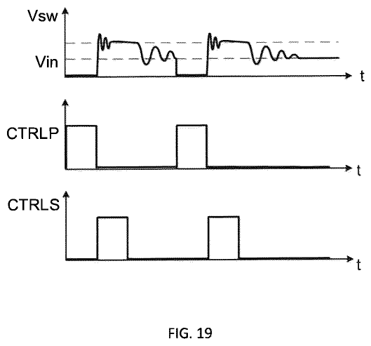

FIG. 19 illustrates a working waveform of the switching converter 400C in accordance with an embodiment of the present invention. As shown in FIG. 19, when the primary switch MP is turned on and the secondary switch MS is turned off, the switching voltage Vsw is zero substantially. When the primary switch MP is turned off and the secondary switch MS is turned on, the output voltage Vout is reflected to the drain terminal of the primary switch MP through the transformer T1. At this time, Vsw=Vin+N*Vout, where N is the turn ratio of the primary winding Pri to the secondary winding Sec.

In one embodiment, the primary sensing circuit 428C is enabled when the primary control circuit 45C is in the low power mode and is disabled when the primary control circuit 45C is in the normal power mode. During the time period when the primary control circuit 45C is in the low power mode, when the primary sensing circuit 428C detects that the switching voltage Vsw increases to Vin+N*Vout from Vin, it is determined that the secondary control circuit 44C has exited the low power mode, the primary control circuit 45C is configured to exit the low power mode.

In the example shown in FIG. 18, the primary control circuit 45C further includes a voltage divider 4211 for generating a scaled switching voltage Vs indicative of the switching voltage Vsw. In one embodiment, the voltage divider 4211 includes resistors R5 and R6. The primary sensing circuit 428C includes a comparator CMP5. When the primary sensing circuit 428C detects that the scaled switching voltage Vs is higher than a switching voltage threshold Vsth, it is determined that the secondary control circuit 44C has exited the low power mode, the primary control circuit 45C is configured to exit the low power mode.

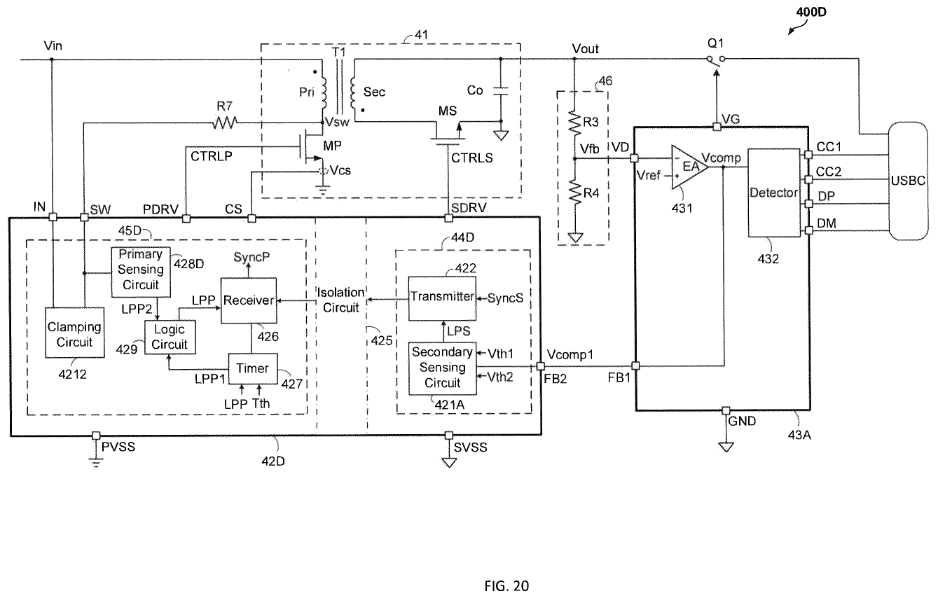

FIG. 20 illustrates a circuit schematic of the switching converter 400D in accordance with another embodiment of the present invention. Different from the control circuit 42C shown in FIG. 18, the control circuit 42D shown in FIG. 20 includes an input pin IN coupled to receive the input voltage Vin and a switching pin SW coupled to the primary switch MP through a resistor R7. The control circuit 42D further includes a clamping circuit 4212 coupled to the input pin IN and the switching pin SW. The clamping circuit 4212 is configured to clamp the voltage at the switching pin SW to be equal to the voltage at the input pin IN (i.e., the input voltage Vin).

When the primary switch MP and the secondary switch MS are both turned off, the switching voltage Vsw is equal to the input voltage Vin(i.e., the switching voltage Vsw is equal to the voltage at the switching pin SW), and the voltage across the resistor R7 is zero substantially, thus there is no current flowing into the switching pin SW substantially. When the valid secondary switch control CTRLS is provided to turn on the secondary switch MS, the switching voltage Vsw is the sum of the input voltage Vin and the product of N and Vout (i.e., Vsw=Vin+N*Vout), thus the voltage across the resistor R7 is the product of N and Vout (i.e., N*Vout), and there is a current flowing into the switching pin SW.

During the time period when the primary control circuit 45D is in the low power mode, the primary sensing circuit 428D is enabled to detect whether there is a current flowing into the switching pin SW. When the current flowing into the switching pin SW is detected, it is determined that the secondary control circuit 44D has exited the low power mode, the primary control circuit 45D is configured to exit the low power mode.

Those skilled in the art can understand that the connection of the control circuit 42 and the PD controller 43 shown in FIG. 14˜FIG. 20 is used for illustration purposes, not for limiting the present invention, other suitable connection configurations can also be applicable.

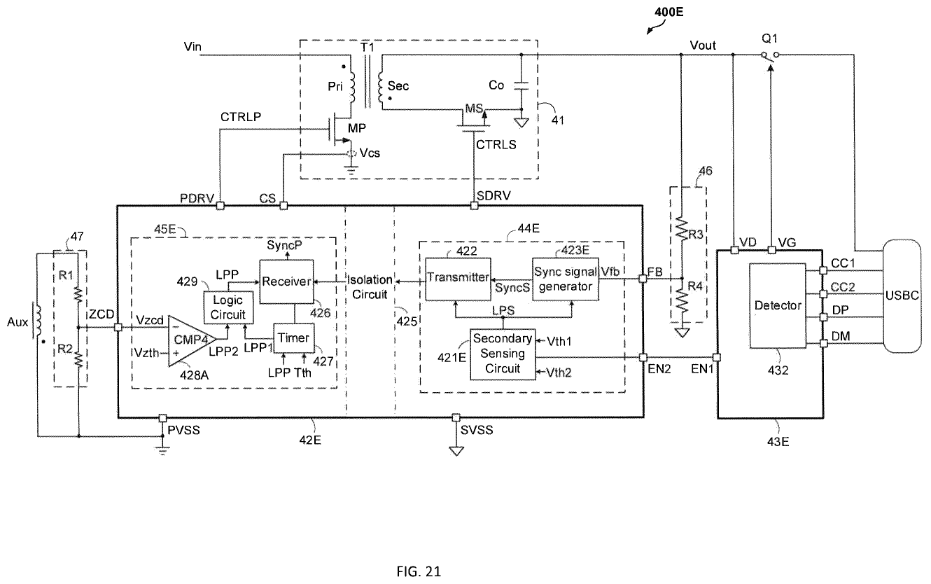

FIG. 21 illustrates a circuit schematic of a switching converter 400E in accordance with another embodiment of the present invention. Different from the PD controller 43A and the control circuit 42A shown in FIG. 14, the PD controller 43E includes an enable pin EN1 and the control circuit 42E includes an enable pin EN2 coupled to the enable pin EN1.

In one embodiment, when the PD controller 43E detects that the load is disconnected from the USB port USBC, the PD controller 43E pulls the voltage at the enable pin EN1 low. When the secondary sensing circuit 421E detects that the voltage at the enable pin EN2 satisfies a low power entering condition, for example, the voltage at the enable pin EN2 is lower than the first feedback threshold Vth1, the secondary control circuit 44E is configured to enter the low power mode from the normal power mode.

In one embodiment, when the PD controller 43E detects that the load is reconnected to the USB port USBC, the PD controller 43E pulls the voltage at the enable pin EN1 high. When the secondary sensing circuit 421E detects that the voltage at the enable pin EN2 satisfies a low power exiting condition, for example, the voltage at the enable pin EN2 is higher than the second feedback threshold Vth2, the secondary control circuit 44E is configured to exit the low power mode and to enter the normal power mode.

In one embodiment, during the time period when the load is disconnected from the USB port USBC, when the PD controller 43E detects that the output voltage Vout decreases to the fourth output threshold Vo4, the PD controller 43E pulls the voltage at the enable pin EN1 high to inform the secondary control circuit 44E to exit the low power mode; when the PD controller 43E detects that the output voltage Vout increases to the third output threshold Vo3, the PD controller 43E pulls the voltage at the enable pin EN1 low to inform the secondary control circuit 44E to enter the low power mode.

In other embodiments, the PD controller 43E can also pull the voltage at the enable pin EN1 high to inform the secondary control circuit 44E to enter the low power mode and pull the voltage at the enable pin EN1 low to inform the secondary control circuit 44E to exit the low power mode. In other words, when the voltage at the enable pin EN2 is higher than the second feedback threshold, the low power entering condition is satisfied, the secondary control circuit 44E is configured to enter the low power mode; when the voltage at the enable pin EN2 is lower than the first feedback threshold, the low power exiting condition is satisfied, the secondary control circuit 44E is configured to exit the low power mode.

The sync signal generator 423E is coupled to the output feedback circuit 46 through the feedback pin FB to receive the output feedback signal Vfb indicative of the output voltage Vout and generates the secondary sync signal SyncS based on the output feedback signal Vfb. When the transmitter 422 is enabled, the transmitter 422 is configured to modulate the secondary sync signal SyncS and to transmit the modulated secondary sync signal to the primary control circuit 45E. The working principles of other modules are similar with the example shown in FIG. 14, thus are omitted for clarity here.

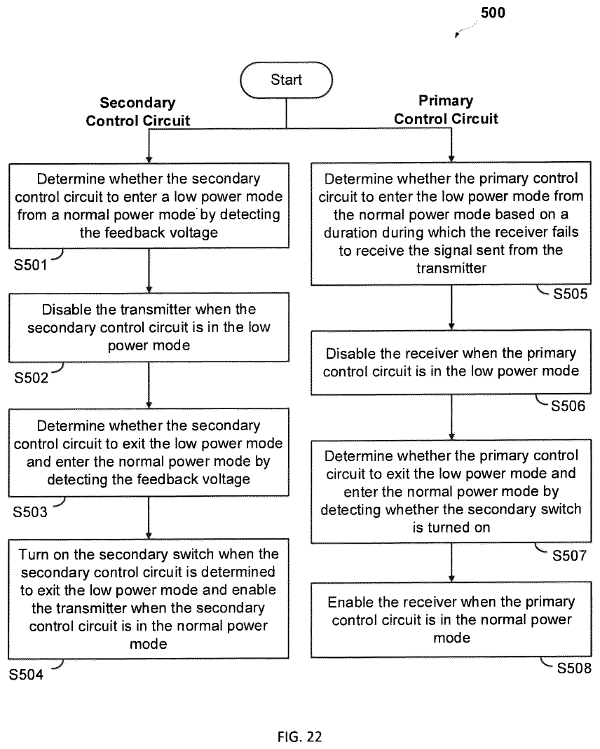

FIG. 22 illustrates a working flowchart of a control method 500 for a switching converter in accordance with an embodiment of the present invention. The switching converter includes a transformer having a primary winding and a secondary winding, a primary switch coupled to the primary winding, a secondary switch coupled to the secondary winding and an output capacitor. The switching converter further includes a control circuit for controlling the power operation of the switching converter. The control circuit includes a first pin receiving a feedback voltage indicating a load condition of the switching converter, a primary control circuit and a secondary control circuit. The control method includes steps S501˜S508.

At step S501, whether the secondary control circuit enters a low power mode from a normal power mode is determined by detecting the feedback voltage. In one embodiment, when the feedback voltage is lower than a first feedback threshold, the secondary control circuit is determined to enter the low power mode.

At step S502, a transmitter of the secondary control circuit is disabled when the secondary control circuit is in the low power mode.

At step S503, whether the secondary control circuit exits the low power mode and enters the normal power mode is determined by detecting the feedback voltage. In one embodiment, when the feedback voltage is higher than a second feedback threshold, the secondary control circuit is determined to exit the low power mode.

At step S504, the secondary switch is turned on when the secondary control circuit is determined to exit the low power mode and the transmitter is enabled when the secondary control circuit is in the normal power mode. In one embodiment, when the transmitter is enabled, the transmitter modulates a secondary sync signal and transmits the modulated secondary sync signal to the primary control circuit. A receiver of the primary control circuit receives and demodulates the modulated secondary sync signal sent from the transmitter and generates a primary sync signal. Then the primary control circuit can generate a primary switch control signal to control the primary switch based on the primary sync signal.

At step S505, whether the primary control circuit enters the low power mode from the normal power mode is determined based on a duration during which the receiver fails to receive the modulated secondary sync signal sent from the transmitter.

At step S506, the receiver is disabled when the primary control circuit is in the low power mode.

At step S507, whether the primary control circuit exits the low power mode and enters the normal power mode is determined by detecting whether the secondary switch is turned on. In one embodiment, a voltage across an auxiliary winding of the transformer is detected to determine whether the secondary switch is turned on. In another embodiment, a supply voltage for the primary control circuit is detected to determine whether the secondary switch is turned on, where the supply voltage is charged by the auxiliary winding of the transformer. In yet another embodiment, a drain voltage of the primary switch is detected to determine whether the secondary switch is turned on.

At step S508, the receiver is enabled when the primary control circuit is in the normal power mode.

Those skilled in the art can understand that the logical high/logical low of control signal is related to the type of the power switch. The logical high/logical low of the control signals shown in the above embodiments are used for illustrative purposes, not used for limiting the present invention.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A control circuit for a switching converter, comprising:
a first pin; and
a secondary control circuit comprising a transmitter and configured to determine whether to enter a low power mode from a normal power mode based on a voltage at the first pin; and wherein
the transmitter is configured to be enabled to modulate a secondary sync signal and to transmit the modulated secondary sync signal to a primary control circuit when the secondary control circuit is in the normal power mode, and is configured to be disabled when the secondary control circuit is in the low power mode.

2. The control circuit of claim 1, wherein the primary control circuit comprises:
a receiver configured to be enabled to demodulate the modulated secondary sync signal and to generate a primary sync signal to control a primary switch when the primary control circuit is in the normal power mode and is configured to be disabled when the primary control circuit is in the low power mode.

3. The control circuit of claim 2, wherein when a duration during which the receiver fails to receive the modulated secondary sync signal exceeds a duration threshold, the primary control circuit is configured to enter the low power mode from the normal power mode.

4. The control circuit of claim 1, wherein the secondary control circuit is configured to determine whether to exit the low power mode based on the voltage at the first pin, and is configured to provide a secondary switch control signal to turn on a secondary switch when the secondary control circuit determines to exit the low power mode.

5. The control circuit of claim 4, wherein the primary control circuit is configured to determine whether to exit the low power mode by detecting whether the secondary switch is turned on.

6. The control circuit of claim 5, further comprising:
a second pin configured to be coupled to an auxiliary winding of the switching converter to detect a voltage across the auxiliary winding; and
a primary sensing circuit coupled to the second pin and configured to detect whether the secondary switch is turned on based on a voltage at the second pin.

7. The control circuit of claim 5, further comprising:
a second pin configured to be coupled to an auxiliary winding of the switching converter through a unidirectional device and configured to provide a supply voltage to the primary control circuit; and
a primary sensing circuit coupled to the second pin and configured to detect whether the secondary switch is turned on based on a voltage at the second pin.

8. The control circuit of claim 5, further comprising:
a second pin configured to receive a drain voltage of a primary switch; and
a primary sensing circuit coupled to the second pin and configured to detect whether the secondary switch is turned on based on a voltage at the second pin.

9. The control circuit of claim 5, further comprising:
a second pin configured to receive a drain voltage of the primary switch through a resistor;
a third pin configured to receive an input voltage of the switching converter;
a clamping circuit coupled to the second pin and the third pin and configured to clamp a voltage at the second pin to be equal to a voltage at the third pin; and
a primary sensing circuit coupled to the second pin and configured to detect whether the secondary switch is turned on by detecting whether there is a current flowing into the second pin.

10. A switching converter, comprising:
a transformer having a primary winding and a secondary winding;
a primary switch coupled to the primary winding;
a secondary switch coupled to the secondary winding; and
a control circuit configured to control the primary switch and the secondary switch; wherein
the control circuit comprises:
a first pin;
a secondary control circuit comprising a transmitter and configured to determine whether to enter a low power mode from a normal power mode based on a voltage at the first pin; and
a primary control circuit comprising a receiver; wherein the transmitter is configured to be enabled to modulate a secondary sync signal and to transmit the modulated secondary sync signal to the receiver when the secondary control circuit is in the normal power mode, and is configured to be disabled when the secondary control circuit is in the low power mode; and wherein
the receiver is configured to be enabled to demodulate the modulated secondary sync signal and to generate a primary sync signal to control the primary switch when the primary control circuit is in the normal power mode and is configured to be disabled when the primary control circuit is in the low power mode.

11. The switching converter of claim 10, wherein the primary control circuit is configured to determine whether to enter the low power mode from the normal power mode based on a duration during which the receiver fails to receive the modulated secondary sync signal.

12. The switching converter of claim 10, wherein the secondary control circuit is configured to determine whether to exit the low power mode based on the voltage at the first pin, and is configured to provide a secondary switch control signal to turn on the secondary switch when the secondary control circuit determines to exit the low power mode.

13. The switching converter of claim 12, wherein the primary control circuit is configured to determine whether to exit the low power mode by detecting whether the secondary switch is turned on.

14. The switching converter of claim 13, wherein the transformer further has an auxiliary winding, and the switching converter further comprises:
an auxiliary voltage detecting circuit configured to detect a voltage across the auxiliary winding and to provide an auxiliary winding voltage signal; and
a primary sensing circuit configured to detect whether the secondary switch is turned on based on the auxiliary winding voltage signal.

15. The switching converter of claim 13, wherein the transformer further has an auxiliary winding with a first terminal and a second terminal, and the switching converter further comprises:
a unidirectional device having an anode and a cathode, wherein the anode is coupled to the first terminal of the auxiliary winding;
a capacitor having a first terminal and a second terminal, wherein the first terminal is coupled to the cathode of the unidirectional device, and the second terminal is coupled to the second terminal of the auxiliary winding; and
a primary sensing circuit configured to detect whether the secondary switch is turned on based on a voltage across the capacitor.

16. A control method for a switching converter, comprising:
detecting a feedback voltage indicating a load condition of the switching converter;
determining whether a secondary control circuit to enter a low power mode from a normal power mode based on the feedback voltage;
enabling a transmitter to modulate a secondary sync signal and to transmit the modulated secondary sync signal to a receiver when the secondary control circuit is in the normal power mode; and
disabling the transmitter when the secondary control circuit is in the low power mode.

17. The control method of claim 16, further comprising:
determining whether a primary control circuit to enter the low power mode from the normal power mode;
enabling the receiver to demodulate the modulated secondary sync signal when the primary control circuit is in the normal power mode; and
disabling the receiver when the primary control circuit is in the low power mode.

18. The control method of claim 17, wherein the step of determining whether the primary control circuit to enter the low power mode comprises:
timing a first duration during which the receiver fails to receive the modulated secondary sync signal; and
configuring the primary control circuit to enter the low power mode when the first duration exceeds a duration threshold.

19. The control method of claim 16, further comprising:
determining whether the secondary control circuit to exit the low power mode based on the feedback voltage; and
turning on a secondary switch when the secondary control circuit determines to exit the low power mode.

20. The control method of claim 19, further comprising:
determining whether a primary control circuit to exit the low power mode by detecting whether the secondary switch is turned on.
